(19) United States
(12) Patent Application Publication
(10) Pub. No.: US 2018/0143480 A1
(43) Pub. Date: May 24, 2018

(54) LIQUID CRYSTAL CELL, THREE-DIMENSIONAL STRUCTURAL LIQUID CRYSTAL CELL PRECURSOR, AND METHOD OF MANUFACTURING THREE-DIMENSIONAL STRUCTURAL LIQUID CRYSTAL CELL

(71) Applicant: FUJIFILM Corporation, Tokyo (JP)

(72) Inventor: Junichi HIRAKATA, Kanagawa (JP)

(73) Assignee: FUJIFILM Corporation, Tokyo (JP)

(21) Appl. No.: 15/860,335

(22) Filed: Jan. 2, 2018

Related U.S. Application Data
(63) Continuation of application No. PCT/JP2016/071588, filed on Jul. 22, 2016.

(30) Foreign Application Priority Data
Jul. 23, 2015 (JP) 2015-146213

(51) Int. Cl. G02F 1/1333; B29C 61/02

(52) U.S. Cl. CPC G02F 1/133305; G02F 1/1339; G02F 2201/56; B29C 61/025

(57) ABSTRACT

An object of the invention is to provide a liquid crystal cell which realizes three-dimensional formability with a high degree of freedom, a method of manufacturing a three-dimensional structural liquid crystal cell which realizes three-dimensional formability with a high degree of freedom, and a three-dimensional structural liquid crystal cell precursor which is used in the manufacturing of the three-dimensional structural liquid crystal cell. A liquid crystal cell according to the invention includes at least two plastic substrates and a liquid crystal layer, and at least one of the plastic substrates is a heat-shrinkable film satisfying a heat shrinkage rate of 5% to 75%.

### CROSS-REFERENCE TO RELATED APPLICATIONS

This application is a Continuation of PCT International Application No. PCT/JP2016/071588 filed on Jul. 22, 2016, which claims priority under 35 U.S.C. § 119(a) to Japanese Patent Application No. 2015-146213 filed on Jul. 23, 2015. The above application is hereby expressly incorporated by reference, in its entirety, into the present application.

### BACKGROUND OF THE INVENTION

### 1. Field of the Invention

The present invention relates to a liquid crystal cell using a heat-shrinkable film as a plastic substrate.

In addition, the invention relates to a method of manufacturing a three-dimensional structural liquid crystal cell having a three-dimensional structure and a three-dimensional structural liquid crystal cell precursor which is used in the manufacturing of the three-dimensional structural liquid crystal cell having a three-dimensional structure.

### 2. Description of the Related Art

In recent years, liquid crystal display devices have been developed into various forms, and flexible displays which are lightweight and can be bent have attracted attention.

In a liquid crystal cell which is used in such a flexible display, a glass substrate which has been used is difficult to meet the demand for weight reduction and bending. Accordingly, various plastic substrates have been examined as a replacement for the glass substrate.

The liquid crystal cell is also used in a dimming device which is used for interior decoration, a building material, a vehicle, or the like. These dimming devices are also desired to be reduced in weight and to have flexibility for bending, and regarding a substrate for these uses, a plastic substrate is required to be put into practical use as a replacement for the glass substrate.

Due to such circumstances, techniques for forming a plastic liquid crystal cell which is lightweight and can be bent have been proposed from various viewpoints.

For example, JP1995-140451A (JP-H07-140451A) discloses a technique for holding a display panel in a curved shape in a temperature region which is equal to or higher than a glass transition temperature of a polymer for forming a plastic substrate of the display panel.

JP1994-18856A (JP-H06-18856A) discloses a technique for forming a cut at a peripheral edge part such that wrinkles are not generated by distortion stress in forming a dimming element into a shape corresponding to a three-dimensional curved glass.

JP2010-224110A discloses a technique for suppressing the occurrence of electrode peeling or cracking through a step of crystallizing a transparent electrode having an amorphous state by curving and heating a display cell including a plastic substrate having the transparent electrode having an amorphous state.

### SUMMARY OF THE INVENTION

Recently, there has been a demand for processing a display device into a shape having a complicated curved surface such as apparel or sunglasses or a demand for installing a dimming device as a three-dimensionally curved formed body, as well as the above-described demand for simple bending.

However, as a result of the studies of the inventors, it has been found that it is difficult to perform forming into a complicated curved surface or a three-dimensionally curved formed body with a simple curving technique as in JP1995-140451A (JP-H07-140451A) and JP2010-224110A. Similarly, it has been found that it is difficult to follow a three-dimensionally curved formed body with the technique of JP1994-18856A (JP-H06-18856A).

Therefore, in fact, it is difficult to obtain a liquid crystal cell which realizes formability into a complicated curved surface or a three-dimensionally curved formed body (hereinafter, referred to as “three-dimensional formability with a high degree of freedom).

Accordingly, an object of the invention is to provide a liquid crystal cell which realizes three-dimensional formability with a high degree of freedom, a method of manufacturing a three-dimensional structural liquid crystal cell which realizes three-dimensional formability with a high degree of freedom, and a three-dimensional structural liquid crystal cell precursor which is used in the manufacturing of the three-dimensional structural liquid crystal cell.

The inventors have conducted intensive studies, and found that it is possible to achieve three-dimensional formability with a high degree of freedom by producing a heat-shrinkable film as a plastic substrate which is used in a liquid crystal cell.

That is, it has been found that the above-described object can be achieved with the following configuration.

[1] A liquid crystal cell comprising: at least two plastic substrates; and a liquid crystal layer, in which at least one of the plastic substrates is a heat-shrinkable film satisfying a heat shrinkage rate of 5% to 75%.

[2] The liquid crystal cell according to [1], in which the heat-shrinkable film is an unstretched thermoplastic resin film.

[3] The liquid crystal cell according to [1], in which the heat-shrinkable film is a thermoplastic resin film stretched at a ratio of greater than 0% and not greater than 300%.

[4] The liquid crystal cell according to any one of [1] to [3], in which all the plastic substrates are heat-shrinkable films satisfying a heat shrinkage rate of 5% to 75%.

[5] A method of manufacturing a three-dimensional structural liquid crystal cell, comprising: shrinking the liquid crystal cell according to any one of [1] to [4] to form a three-dimensional structural liquid crystal cell.

[6] The method of manufacturing a three-dimensional structural liquid crystal cell according to [5], in which the shrinkage is performed by heating.

[7] The method of manufacturing a three-dimensional structural liquid crystal cell according to [5] or [6], in which at least one of the at least two plastic substrates of the liquid crystal cell has a thickness of 10 μm to 500 μm after shrinkage.

[8] A three-dimensional structural liquid crystal cell precursor comprising: the liquid crystal cell according to any one of [1] to [4], in which the liquid crystal cell has a tubular shape.

[9] The three-dimensional structural liquid crystal cell precursor according to [8], in which all sides of the tubular shape are sealed.

[10] A method of manufacturing a three-dimensional structural liquid crystal cell, comprising: shrinking the three-dimensional structural liquid crystal cell precursor according to [8] or [9] to form a three-dimensional structural liquid crystal cell.

[11] The method of manufacturing a three-dimensional structural liquid crystal cell according to [10], in which the shrinkage is performed by heating.

[12] The method of manufacturing a three-dimensional structural liquid crystal cell according to [10] or [11], in which a peripheral length L0 before shrinkage and a peripheral length L after shrinkage satisfy Expression 1.

5≤100×(L0−L)/L0≤75 (Expression 1)

[13] The method of manufacturing a three-dimensional structural liquid crystal cell according to any one of [10] to [12], in which at least one of the at least two plastic substrates of the three-dimensional structural liquid crystal cell precursor has a thickness of 10 μm to 500 μm after shrinkage.

According to the invention, it is possible to provide a liquid crystal cell which realizes three-dimensional formability with a high degree of freedom, a method of manufacturing a three-dimensional structural liquid crystal cell which realizes three-dimensional formability with a high degree of freedom, and a three-dimensional structural liquid crystal cell precursor which is used in the manufacturing of the three-dimensional structural liquid crystal cell.

### BRIEF DESCRIPTION OF THE DRAWINGS

FIG. 1A is a schematic view illustrating a method of producing a three-dimensional structural liquid crystal cell using a three-dimensional structural liquid crystal cell precursor according to the invention, and is a schematic view illustrating a state before heating and forming.

FIG. 1B is a schematic view illustrating the method of producing a three-dimensional structural liquid crystal cell using a three-dimensional structural liquid crystal cell precursor according to the invention, and is a schematic view illustrating a state after heating and forming.

FIG. 2A is a schematic view illustrating another method of producing a three-dimensional structural liquid crystal cell using a three-dimensional structural liquid crystal cell precursor according to the invention, and is a schematic view illustrating a state before heating and forming.

FIG. 2B is a schematic view illustrating another method of producing a three-dimensional structural liquid crystal cell using a three-dimensional structural liquid crystal cell precursor according to the invention, and is a schematic view illustrating a state after heating and forming.

### DESCRIPTION OF THE PREFERRED EMBODIMENTS

Hereinafter, the invention will be described in detail.

The following description of constituent requirements is based on typical embodiments of the invention, but the invention is not limited thereto.

In this specification, a numerical value range expressed using “to” means a range including numerical values before and after “to” as a lower limit value and an upper limit value.

In this specification, parallel or perpendicular does not mean parallel or perpendicular in a strict sense, but means a range of having ±5° from parallel or perpendicular.

<Liquid Crystal Cell>

A liquid crystal cell according to the invention has at least two plastic substrates and a liquid crystal layer. At least one of the plastic substrates is a heat-shrinkable film satisfying a heat shrinkage rate of 5% to 75%.

In the invention, a liquid crystal cell includes a liquid crystal cell which is used in a liquid crystal display device for use in a thin television, a monitor, a laptop computer, a cell phone, or the like, and a liquid crystal cell which is used in a dimming device which changes the intensity of light to be applied for interior decoration, a building material, a vehicle, or the like.

That is, a liquid crystal cell is a generic term for devices which drive a liquid crystal material or the like enclosed between two substrates.

In this specification, the terms liquid crystal cell before shrinkage, three-dimensional structural liquid crystal cell precursor including tubular liquid crystal cell before shrinkage, and three-dimensional structural liquid crystal cell after shrinkage may be separately used.

In addition, a liquid crystal cell according to the invention, that is, a liquid crystal cell having a heat-shrinkable film satisfying a heat shrinkage rate of 5% to 75% as at least one plastic substrate means a liquid crystal cell for forming before heat shrinkage.

Regarding drive modes of the liquid crystal cell, various methods can be used including a horizontal alignment mode (In-Plane-Switching: IPS), a vertical alignment mode (Vertical Alignment: VA), a twisted nematic mode (Twisted Nematic: TN), and a super twisted nematic mode (Super Twisted Nematic: STN).

In the liquid crystal cell according to the invention, a conductive film for driving a liquid crystal by applying a voltage, an alignment film for putting liquid crystal molecules into a desired alignment state, dye molecules used to change the intensity of light in a dimming element, and the like may be used in combination.

Various spacers such as beads and columnar materials for providing a constant cell gap can also be preferably used.

As a method for sealing a material in the liquid crystal cell in an airtight manner, various adhesives, heat fusion welding of a plastic substrate, physical pressure bonding and fixing, or the like can be used.

A backlight member, a polarizer member, or the like may be additionally provided or bonded to the outside of the liquid crystal cell in accordance with the configuration of the liquid crystal cell.

[Plastic Substrate]

In the liquid crystal cell according to the invention, a plastic substrate is used in place of a conventional glass substrate in order to realize three-dimensional formability with a high degree of freedom.

As the plastic substrate, a thermoplastic resin is preferably used, and as the thermoplastic resin, a polymer resin is preferable which is excellent in optical transparency, mechanical strength, heat stability, and the like.

Examples of the polymer included in the plastic substrate include polycarbonate-based polymers; polyester-based polymers such as polyethylene terephthalate (PET); acryl-based polymers such as polymethylmethacrylate (PMMA); and styrene-based polymers such as polystyrene and acrylonitrile-styrene copolymers (AS resin).

Examples of the polymer further include polyolefins such as polyethylene and polypropylene; polyolefin-based polymers such as norbornene-based resins and ethylene-propylene copolymers; amide-based polymers such as vinyl chloride-based polymers, nylon, and aromatic polyamides; imide-based polymers; sulfone-based polymers; polyether sulfone-based polymers; polyetheretherketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; cellulose-based polymers represented by triacetylcellulose; and copolymers copolymerized in units of monomers of the above polymers.

Examples of the plastic substrate also include a substrate formed by mixing two or more kinds of the polymers mentioned above as examples.

{Heat-Shrinkable Film}

In the liquid crystal cell according to the invention, at least one of the at least two plastic substrates is a heat-shrinkable film satisfying a heat shrinkage rate of 5% to 75%.

By shrinking the heat-shrinkable film, it is possible to realize three-dimensional formability with a high degree of freedom.

Means for shrinkage is not particularly limited, and examples thereof include shrinkage by stretching during the course of film formation. The effect caused by shrinkage of the film itself, shrinkage by residual distortion during film formation, shrinkage by a residual solvent, or the like can also be used.

<Heat Shrinkage Rate>

The heat shrinkage rate of the heat-shrinkable film used in the invention is 5% to 75%, preferably 7% to 60%, and more preferably 10% to 45%.

In the heat-shrinkable film used in the invention, the maximum heat shrinkage rate in an in-plane direction of the heat-shrinkable film is preferably 5% to 75%, more preferably 7% to 60%, and even more preferably 10% to 45%. In a case where stretching is performed as means for shrinkage, the in-plane direction in which the maximum heat shrinkage rate is shown coincides with a stretching direction.

In the heat-shrinkable film used in the invention, the heat shrinkage rate in a direction perpendicular to the in-plane direction in which the maximum heat shrinkage rate is shown is preferably 0% to 5%, and more preferably 0% to 3%.

A measurement sample is cut every 5° in the measurement of a heat shrinkage rate under conditions to be described later, heat shrinkage rates in an in-plane direction of all of the measurement samples are measured, and the in-plane direction in which the maximum heat shrinkage rate is shown is specified by a direction in which the maximum measurement value is shown.

In the invention, the heat shrinkage rate is a value measured under the following conditions.

To measure the heat shrinkage rate, a measurement sample having a length of 15 cm and a width of 3 cm with a long side in a measurement direction was cut, and 1 cm-squares were stamped on one film surface in order to measure the film length. A point separated from an upper part of a long side of 15 cm by 3 cm on a central line having a width of 3 cm was set as A, a point separated from a lower part of the long side by 2 cm was set as B, and a distance AB of 10 cm between the points was defined as an initial film length L₀. The film was clipped up to 1 cm away from the upper part of the long side with a clip having a width of 5 cm and hung from the ceiling of an oven heated to a glass transition temperature (Tg) of the film. In this case, the film was put into a tension-free state while not being weighted. The entire film was sufficiently and uniformly heated, and after 5 minutes, the film was taken out of the oven for each clip to measure a length L between the points A and B after the heat shrinkage, and a heat shrinkage rate was obtained through Expression 2.

Heat Shrinkage Rate (%)=100×(L₀−L)/L₀ (Expression 2)

(Glass Transition Temperature (Tg))

The Tg of the heat-shrinkable film used in the invention can be measured using a differential scanning calorimeter.

Specifically, the measurement was performed using a differential scanning calorimeter DSC7000X manufactured by Hitachi High-Tech Science Corporation under conditions of a nitrogen atmosphere and a heating rate of 20° C./min, and a temperature at a point where tangents of respective DSC curves at a peak top temperature of a time differential DSC curve (DDSC curve) of the obtained result and at a temperature of (peak top temperature−20° C.) intersected was set as a Tg.

<Stretching Step>

The heat-shrinkable film used in the invention may be an unstretched thermoplastic resin film, but preferably a stretched thermoplastic resin film.

The stretching ratio is not particularly limited, but preferably greater than 0% and not greater than 300%. The stretching ratio is more preferably greater than 0% and not greater than 200%, and even more preferably greater than 0% and not greater than 100% from the practical stretching step.

The stretching may be performed in a film transport direction (longitudinal direction), in a direction perpendicular to the film transport direction (transverse direction), or in both of the directions.

The stretching temperature is preferably around the glass transition temperature Tg of the heat-shrinkable film to be used, more preferably Tg±0° C. to 50° C., even more preferably Tg±0° C. to 40° C., and particularly preferably Tg±0° C. to 30° C.

In the invention, the film may be biaxially stretched simultaneously or sequentially in the stretching step. In a case of sequential biaxial stretching, the stretching temperature may be changed for each stretching in each direction.

In a case of sequential biaxial stretching, it is preferable that first, the film is stretched in a direction parallel to the film transport direction, and then stretched in a direction perpendicular to the film transport direction. The stretching temperature range in which the sequential stretching is performed is more preferably the same as a stretching temperature range in which the simultaneous biaxial stretching is performed.

<Three-Dimensional Structural Liquid Crystal Cell Precursor>

A three-dimensional structural liquid crystal cell precursor according to the invention includes a tubular liquid crystal cell.

The method for forming into a tubular shape is not particularly limited, and examples thereof include a method of pressure-bonding sides of a sheet-like liquid crystal cell facing each other. The shape of the interior of the tube is not particularly limited. It may be an annular shape, an elliptical shape, or a free shape having a curved surface when the tube is viewed from the top.

All sides of the tubular shape of the three-dimensional liquid crystal cell precursor, that is, all end parts of the tubular shape are preferably sealed.

<Method of Manufacturing Three-Dimensional Structural Liquid Crystal Cell>

A method of manufacturing a three-dimensional structural liquid crystal cell according to the invention is a method of shrinking the liquid crystal cell according to the invention or the three-dimensional structural liquid crystal cell precursor according to the invention having a tubular shape, which have been described above, to form a three-dimensional structural liquid crystal cell.

For example, by shrinking and forming according to a body shaped like a beverage bottle, a display device or a dimming device can be installed on the bottle, or a display device covering the vicinity of the cylindrical structure can be realized.

In the method of manufacturing a three-dimensional structural liquid crystal cell according to the invention, it is preferable that a peripheral length L0 before shrinkage and a peripheral length L after shrinkage satisfy Expression 1 for production.

5≤100×(L0−L)/L0≤75 (Expression 1)

Here, the peripheral length L after shrinkage may be different in a plurality of places as long as it is within a range satisfying the above expression. That is, the liquid crystal cell according to the invention can be processed into a three-dimensionally formed body with a higher degree of freedom within a range satisfying the above expression.

In addition, Expression 1 may be satisfied in a partial region in the three-dimensional structural liquid crystal cell according to the invention, and Expression 1 is preferably satisfied in the entire region.

In the forming processing, in a case where a formed body with a high degree of freedom which has a peripheral length smaller than the peripheral length L0 before shrinkage is used inside, the heat-shrinkable film used in the invention shrinks toward the interior side of the tubular shape and a pressure toward the interior side of the tubular shape is applied thereto. In this case, the interior part of the liquid crystal cell is pressed by film shrinkage, and it is preferable that a constant cell gap is held by various spacers in the cell.

In the method of manufacturing a three-dimensional structural liquid crystal cell according to the invention, the heat-shrinkable film is preferably shrunk by heating.

The temperature condition for heating the heat-shrinkable film is preferably higher than a Tg of the film to perform forming and not higher than a melting temperature of the film, that is, 60° C. to 260° C. The temperature condition is more preferably 80° C. to 230° C., and even more preferably 100° C. to 200° C. The heating time is set such that sufficient heat uniformly spreads and film decomposition does not occur by extreme heating, that is, preferably 3 seconds to 30 minutes. The heating time is more preferably 10 seconds to 10 minutes, and even more preferably 30 seconds to 5 minutes. The heat shrinkage rate of the film is preferably 5% to 75% in order to realize three-dimensional formability with a high degree of freedom. The heat shrinkage rate is more preferably 7% to 60%, and even more preferably 10% to 45%. The thickness of the heat-shrinkable film after shrinkage is not particularly limited, preferably 10 μm to 500 μm, and more preferably 20 μm to 300 μm.

In realizing the shrinkage behavior as described above, some thermoplastic resins may rarely shrink due to resin characteristics such as crystallization. For example, polyethylene terephthalate (PET) has high shrinkability if it is amorphous. However, thermal stabilization may increase and shrinkage may rarely occur through polymer chain alignment and crystal fixing by strong stretching. Such a material which rarely shrinks due to the crystallization may not be preferable.

### EXAMPLES

Hereinafter, the invention will be described in detail with reference to examples. The materials, the reagents, the amounts of materials, the proportions thereof, the conditions, the operations, and the like which will be shown in the following examples can be appropriately modified within a range not departing from the gist of the invention. Accordingly, the scope of the invention is not limited to the following examples.

### Example 1

<Production of Liquid Crystal Cell 101>

Polycarbonate (manufactured by TEIJIN LIMITED.) having a thickness of 300 μm was heated for 1 minute at 155° C. and stretched in a transverse direction (TD) at a stretching ratio of 100%. Then, the resulting material was cut into a 10 cm (machine direction (MD))×30 cm (TD) sized piece to obtain a stretched polycarbonate film having a thickness of 150 μm.

The glass transition temperature (Tg) of the stretched polycarbonate film produced as described above was 150° C., and the heat shrinkage rate in the TD measured by the above-described method was 33%.

The in-plane direction in which the maximum heat shrinkage rate was shown substantially coincided with the TD, and the heat shrinkage rate in the MD perpendicular thereto was 3%.

Using the stretched polycarbonate film produced as described above as a plastic substrate, an indium tin oxide (ITO) transparent electrode having a thickness of 20 nm was formed by vacuum deposition, and an alignment film of a vertically aligned polyimide was further formed. Two pieces were prepared in this manner. The two pieces were matched such that the alignment films were positioned inside, and a constant cell gap of 8 μm was kept using a spherical spacer (MICROPEARL SP208 manufactured by SEKISUI FINE CHEMICAL CO., LTD.) to inject the following liquid crystal composition. After that, all the four sides were sealed by curing with a width of 1 cm with an ultraviolet (UV) adhesive to produce a liquid crystal cell 101.

(Liquid Crystal Composition)

| | | |
|---|---|---|
| Drive Liquid Crystal ZLI2806 manufactured by | 100 | wt % |
| Merck KGaA | | |
| Dichroic Dye G-472 manufactured by Japanese Res. | 3.0 | wt % |
| Inst. for Photosensitizing Dyes Co., Ltd. | | |
| Chiral Agent Cholesterol Pelargonate manufactured | 1.74 | wt % |
| by Tokyo Chemical Industry Co., Ltd. | | |

<Production of Three-Dimensional Structural Liquid Crystal Cell Precursor 101>

The liquid crystal cell 101 produced as described above was rolled from its long side which was 30 cm long to have a cylindrical tubular shape. Then, an overlapping part of the sides which were 10 cm long was provided as a 1 cm-part in which the cell was sealed, and a pressure of 1 MPa was applied thereto for 1 minute at 200° C. for thermal pressure bonding and fixing to produce a three-dimensional structural liquid crystal cell precursor 101 having a tubular shape. The peripheral length was 29 cm.

<Production of Three-Dimensional Structural Liquid Crystal Cell 101>

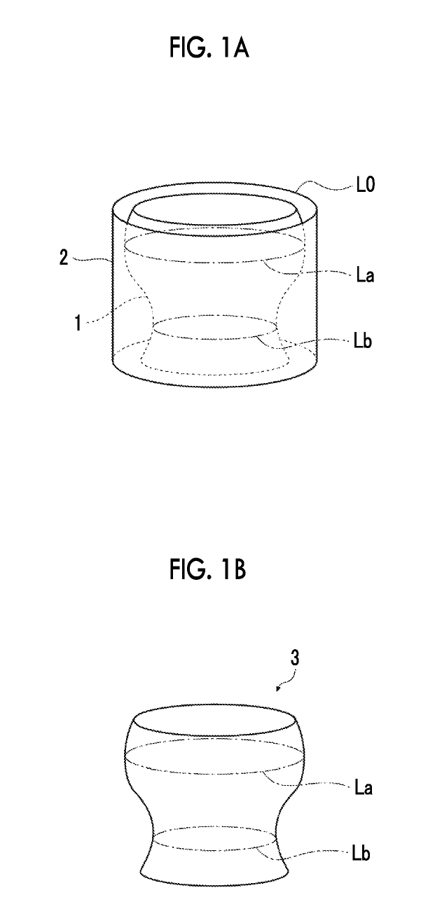

A mold 1 having a shape shown in FIG. 1A was prepared. The maximum peripheral length La was 25 cm, and the minimum peripheral length Lb was 20 cm. The three-dimensional structural liquid crystal cell precursor 101 (reference 2) having a tubular shape with a peripheral length L0 of 29 cm, which had been produced as described above, was disposed at a position shown in FIG. 1A with respect to the mold, and heated and formed for 5 minutes at a temperature of 150° C. to produce a three-dimensional structural liquid crystal cell 101 (reference 3) shown in FIG. 1B. It was possible to perform the forming such that the three-dimensional structural liquid crystal cell precursor followed any of the part having the peripheral length La and the part having the peripheral length Lb. The peripheral lengths of the respective parts were 25 cm and 20 cm, respectively, in accordance with the shape of the mold. In addition, basic performance as a liquid crystal cell did not change.

### Example 2

<Production of Three-Dimensional Structural Liquid Crystal Cell Precursor 102>

A three-dimensional structural liquid crystal cell precursor 102 was produced in the same manner as in Example 1, except that the polycarbonate stretching ratio was changed from 100% to 280%.

The glass transition temperature (Tg) of the stretched polycarbonate film was 150° C., and the heat shrinkage rate in the TD was 70%. The in-plane direction in which the maximum heat shrinkage rate was shown substantially coincided with the TD, and the heat shrinkage rate in the MD perpendicular thereto was 2%.

<Production of Three-Dimensional Structural Liquid Crystal Cell 102>

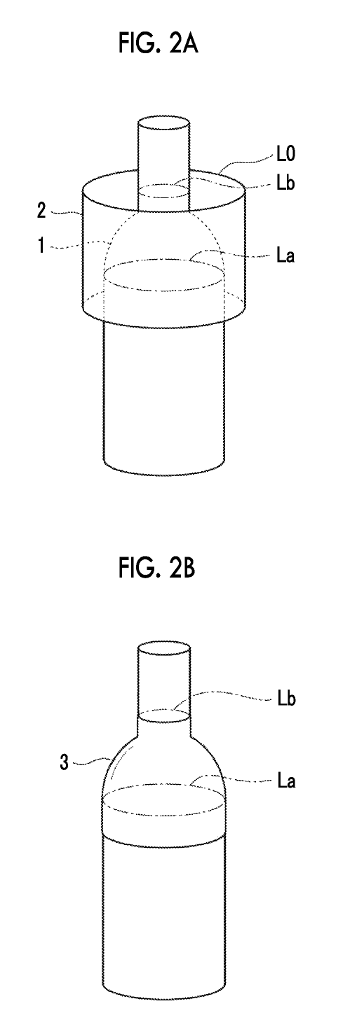

A three-dimensional structural liquid crystal cell 102 was produced in the same manner as in Example 1, except that the three-dimensional structural liquid crystal cell precursor 102 produced as described above was used and a mold having a bottle shape shown in FIGS. 2A and 2B was used.

In a mold 1 having a shape shown in FIG. 2A, the maximum peripheral length La was 25 cm, and the minimum peripheral length Lb was 10 cm. The three-dimensional structural liquid crystal cell precursor 102 (reference 2) having a tubular shape with a peripheral length L0 of 29 cm, which had been produced as described above, was disposed at a position shown in FIG. 2A with respect to the mold, and heated and formed for 5 minutes at a temperature of 150° C. to produce a three-dimensional structural liquid crystal cell 102 (reference 3) as shown in FIG. 2B. It was possible to perform the forming such that the three-dimensional structural liquid crystal cell precursor followed any of the part having the peripheral length La and the part having the peripheral length Lb. The peripheral lengths of the respective parts were 25 cm and 10 cm, respectively, in accordance with the shape of the mold. In addition, basic performance as a liquid crystal cell did not change.

### Example 3

A three-dimensional structural liquid crystal cell precursor 103 was produced in the same manner as in Example 1, except that a cycloolefin polymer (COP) film (ARTON G7810 manufactured by JSR CORPORATION) formed as a film having a thickness of 300 μm through solution film forming was used instead of the 300 μm-polycarbonate, and the stretching temperature was changed from 155° C. to 170° C. The glass transition temperature (Tg) of the COP film was 170° C., and the heat shrinkage rate in the TD was 32%. The in-plane direction in which the maximum heat shrinkage rate was shown substantially coincided with the TD, and the heat shrinkage rate in the MD perpendicular thereto was 3%.

A three-dimensional structural liquid crystal cell 103 was produced in the same manner as in Example 1, except that the three-dimensional structural liquid crystal cell precursor 103 was used and the temperature for heating and forming was changed from 150° C. to 165° C. It was possible to perform the forming such that the three-dimensional structural liquid crystal cell precursor followed any of the part having the peripheral length La and the part having the peripheral length Lb. The peripheral lengths of the respective parts were 25 cm and 20 cm, respectively, in accordance with the shape of the mold. In addition, basic performance as a liquid crystal cell did not change.

### Example 4

A three-dimensional structural liquid crystal cell precursor 104 was produced in the same manner as in Example 1, except that a cellulose acetate film (manufactured by Daicel Corporation) having an acetyl substitution degree of 2.42 and formed as a film having a thickness of 300 μm through solution film forming was used instead of the 300 μm-polycarbonate, and the stretching temperature was changed from 155° C. to 190° C. The glass transition temperature (Tg) of the cellulose acetate film was 180° C., and the heat shrinkage rate in the TD was 30%. The in-plane direction in which the maximum heat shrinkage rate was shown substantially coincided with the TD, and the heat shrinkage rate in the MD perpendicular thereto was 3%.

A three-dimensional structural liquid crystal cell 104 was produced in the same manner as in Example 1, except that the three-dimensional structural liquid crystal cell precursor 104 was used and the temperature for heating and forming was changed from 150° C. to 187° C. It was possible to perform the forming such that the three-dimensional structural liquid crystal cell precursor followed any of the part having the peripheral length La and the part having the peripheral length Lb. The peripheral lengths of the respective parts were 25 cm and 20 cm, respectively, in accordance with the shape of the mold. In addition, the basic performance as a liquid crystal cell did not change.

### Comparative Example 1

A three-dimensional structural liquid crystal cell precursor 201 was produced in the same manner as in Example 1, except that a 300 μm-biaxially stretched PET film (A4300 manufactured by TOYOBO CO., LTD.) was used instead of the 300 μm-polycarbonate, and the stretching temperature was changed from 155° C. to 200° C. The glass transition temperature (Tg) of the biaxially stretched PET film was 80° C., and the heat shrinkage rates in the TD and in the MD were 0.5%.

A three-dimensional structural liquid crystal cell 201 was produced in the same manner as in Example 1, except that the three-dimensional structural liquid crystal cell precursor 201 was used and the temperature for heating and forming was changed from 150° C. to 200° C. Shrinkage rarely occurred due to the crystallinity of the biaxially stretched PET film, and it was not possible for the three-dimensional structural liquid crystal cell precursor to follow any of the part having the peripheral length La and the part having the peripheral length Lb. The peripheral lengths of the respective parts were 27.6 cm and 27.5 cm, respectively. Basic performance as a liquid crystal cell did not change.

### EXPLANATION OF REFERENCES

1: mold

2: three-dimensionally structural liquid crystal cell precursor

3: three-dimensionally structural liquid crystal cell

L0: peripheral length before shrinkage

La: maximum peripheral length

Lb: minimum peripheral length

What is claimed is:

1. A liquid crystal cell comprising:
at least two plastic substrates; and
a liquid crystal layer,
wherein at least one of the plastic substrates is a heat-shrinkable film satisfying a heat shrinkage rate of 5% to 75%.

2. The liquid crystal cell according to claim 1,
wherein the heat-shrinkable film is an unstretched thermoplastic resin film.

3. The liquid crystal cell according to claim 1,
wherein the heat-shrinkable film is a thermoplastic resin film stretched at a ratio of greater than 0% and not greater than 300%.

4. The liquid crystal cell according to claim 1,
wherein all the plastic substrates are heat-shrinkable films satisfying a heat shrinkage rate of 5% to 75%.

5. A method of manufacturing a three-dimensional structural liquid crystal cell, comprising:
shrinking the liquid crystal cell according to claim 1 to form a three-dimensional structural liquid crystal cell.

6. A method of manufacturing a three-dimensional structural liquid crystal cell, comprising:
shrinking the liquid crystal cell according to claim 2 to form a three-dimensional structural liquid crystal cell.

7. A method of manufacturing a three-dimensional structural liquid crystal cell, comprising:
shrinking the liquid crystal cell according to claim 3 to form a three-dimensional structural liquid crystal cell.

8. The method of manufacturing a three-dimensional structural liquid crystal cell according to claim 5,
wherein the shrinkage is performed by heating.

9. The method of manufacturing a three-dimensional structural liquid crystal cell according to claim 5,
wherein at least one of the at least two plastic substrates of the liquid crystal cell has a thickness of 10 μm to 500 μm after shrinkage.

10. The method of manufacturing a three-dimensional structural liquid crystal cell according to claim 8,
wherein at least one of the at least two plastic substrates of the liquid crystal cell has a thickness of 10 μm to 500 μm after shrinkage.

11. A three-dimensional structural liquid crystal cell precursor comprising:
the liquid crystal cell according to claim 1,
wherein the liquid crystal cell has a tubular shape.

12. A three-dimensional structural liquid crystal cell precursor comprising:
the liquid crystal cell according to claim 2,
wherein the liquid crystal cell has a tubular shape.

13. A three-dimensional structural liquid crystal cell precursor comprising:
the liquid crystal cell according to claim 3,
wherein the liquid crystal cell has a tubular shape.

14. The three-dimensional structural liquid crystal cell precursor according to claim 11,
wherein all sides of the tubular shape are sealed.

15. The three-dimensional structural liquid crystal cell precursor according to claim 12,
wherein all sides of the tubular shape are sealed.

16. The three-dimensional structural liquid crystal cell precursor according to claim 13,
wherein all sides of the tubular shape are sealed.

17. A method of manufacturing a three-dimensional structural liquid crystal cell, comprising:
shrinking the three-dimensional structural liquid crystal cell precursor according to claim 11 to form a three-dimensional structural liquid crystal cell.

18. The method of manufacturing a three-dimensional structural liquid crystal cell according to claim 17,
wherein the shrinkage is performed by heating.

19. The method of manufacturing a three-dimensional structural liquid crystal cell according to claim 17,
wherein a peripheral length L0 before shrinkage and a peripheral length L after shrinkage satisfy Expression 1.
5≤100×(L0−L)/L0≤75 (Expression 1)

20. The method of manufacturing a three-dimensional structural liquid crystal cell according to any one of claim 17,
wherein at least one of the at least two plastic substrates of the three-dimensional structural liquid crystal cell precursor has a thickness of 10 μm to 500 μm after shrinkage.
